(19) United States
(12) Patent Application Publication
(10) Pub. No.: US 2014/0033239 A1
(43) Pub. Date: Jan. 30, 2014

(54) NEXT GENERATION TELEVISION WITH CONTENT SHIFTING AND INTERACTIVE SELECTABILITY

(71) Applicants: Peng Wang, Beijing (CN); Wenglong Li, Beijing (CN); Jianguo Li, Beijing (CN); Tao Wang, Beijing (CN); Yangzhou Du, Beijing (CN); Qiang Li, Beijing (CN)

(72) Inventors: Peng Wang, Beijing (CN); Wenglong Li, Beijing (CN); Jianguo Li, Beijing (CN); Tao Wang, Beijing (CN); Yangzhou Du, Beijing (CN); Qiang Li, Beijing (CN)

(21) Appl. No.: 13/976,854

(22) PCT Filed: Apr. 11, 2011
(86) PCT No.: PCT/CN11/00618

§ 371 Date: Oct. 14, 2013

(51) Int. Cl. H04N 21/478

(52) U.S. Cl. CPC H04N 21/478
USPC 725/13

(57) ABSTRACT

Systems and methods for providing next generation television with content shifting and interactive selectability are described. In some examples, image content may be transferred from a television to smaller mobile computing device, and an example-based. visual search may be conducted on a selected portion of the content. Search results may then be provided to the mobile computing, device. In addition, avatar simulation may be undertaken.

### BACKGROUND

Unless otherwise indicated herein, the approaches described in this section are not prior art to the material disclosed in this application and are not admitted to be prior art by inclusion in this section.

Conventional content transition solutions focus on shifting content from a computer such as a personal computer (PC) or a smart phone to a television (TV). In other words, typical approaches shift content from a smaller screen to a larger TV screen to improve the viewing experience for users. However, such approaches may not desirable if a user also wishes to selectively interact with the content as the larger screen usually is located several meters away from a user and interaction with the larger screen is typically provided through either a remote control or through gesture control. While some approaches allow a user to employ a mouse and/or a keyboard as interactive tools, such interactive methods are not as user friendly as might he desirable.

### BRIEF DESCRIPTION OF THE DRAWINGS/FIGURES

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding, or analogous elements.

In the figures:

FIG. 1 is an illustrative diagram of an example multi-screen environment;

FIG. 2 is an illustration of an example process;

FIG. 3 is an illustration of an example system; and

FIG. 4 is an illustration of an example system, all arranged in accordance with at least some embodiments of the present disclosure.

### DETAILED DESCRIPTION

One or more embodiments are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in various architectures, such as a system on-a-chip (SoC) architecture, implementation of the techniques and/or arrangements described herein is not restricted to particular architectures and/or computing systems and may be implemented by any architecture for similar purposes. For example, architectures employing multiple integrated circuit (IC) chips and/or packages, and/or various architectures manifested in computing devices and/or consumer electronic (CE) devices such as set-top boxes (STBs), televisions (TVs), smart phones, tablet computers etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, etc., may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors or processor cores. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described.

This disclosure is drawn inter alia, to methods, apparatus, and systems related to next generation TV.

In accordance with the present disclosure, methods, apparatus, and systems for providing next generation TV with content shifting and interactive selectability are described. In some implementations, schemes for content shifting from a larger TV screen to a mobile computing device having a smaller display screen such as a tablet computer or smart phone are disclosed. In various schemes image content may he synced between a TV screen and a mobile computing device and a user may interact with the image content on the mobile device's display while the same content continues to play on the TV screen. For instance, a user may interact with a mobile device's touchscreen display to select a portion or query region of the image content for subsequent visual search processing. A content analysis process employing automatic visual information processing techniques may then be conducted on the selected query region. The analysis may extract descriptive features such as example Objects from the query region and may use the extracted example objects to conduct a visual search. The corresponding search results may then be stored on the mobile computing device. In addition, the user and/or an avatar simulation of the user may interact with the search results appearing on the mobile computing device display and/or on the TV screen.

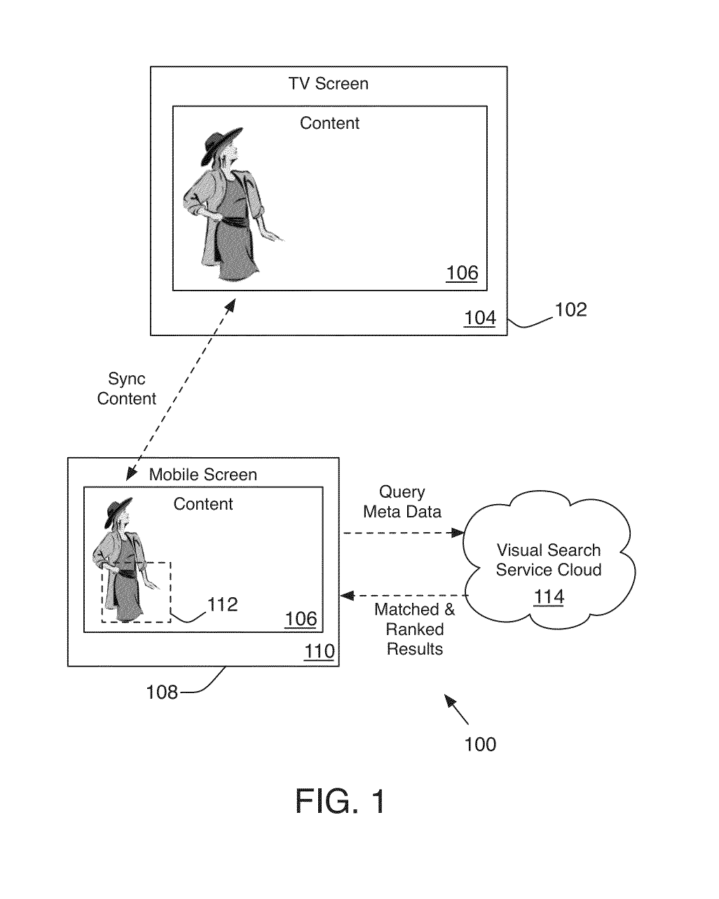

Material described herein may be implemented in the context of a multi-screen environment where a user may have the opportunity to view content on a larger TV screen and to view and interact with the same content on one or more smaller. mobile displays. FIG. 1 illustrates an example multi-screen environment 100 in accordance with the present disclosure. Multi-screen environment 100 includes a TV 102 having a display screen 104 displaying video or image content 106 and a mobile computing device (MCD) 108 having a display screen 110. In various implementations, MCD 108 may be a tablet computer, smart phone or the like, and mobile display screen 110 may be a touchscreen display such as a capacitive touch screen or the like. In various implementations, TV screen 104 has a larger diagonal size than a diagonal size of display screen 110 of mobile computing device 108. For example. TV screen 104 may have a diagonal size of about one meter are larger while mobile display screen 110 may have a diagonal size of about 30 centimeters or smaller.

As will be explained in further detail below, image content 106 appearing on TV screen 104 may be synced, shifted or otherwise transferred to MCD 108 so that content 106 may be viewed contemporaneously on both TV screen 104 and mobile display screen 110. For example, content 106 mar be synced or transferred directly from TV 102 to MCD 108 as shown. Alternatively, in other examples, MCD 108 may receive content 106 in response to meta data specifying a media stream corresponding to content 106 where that meta data has been provided to MCD 108 by TV 102 or another device such as a set-top box (STB) (not shown).

While content 106 may be displayed contemporaneously on both TV screen 104 and mobile display screen 110, the present disclosure is not limited to content 106 being displayed simultaneously on both displays. For instance, the display of content 106 on mobile display screen 110 may not be precisely synchronous with the display of content 106 on TV screen 104. In other words, the display of content 106 on mobile display screen 110 may be delayed with respect to the display of content 106 on TV screen 104. For example, the display of content 106 on mobile display screen 110 may occur fractions of a second or more after the display of content 106 on TV screen 104.

As will also be explained in further detail below, in various implementations a user may select a query region 112 of content 106 appearing on mobile display screen 110 and content analysis such as, for example, image segmentation analysis may be performed on the content within region 112 to generate query meta data. A visual search may then be performed using the query meta data and corresponding matching and ranked search results may be displayed on mobile display screen 110 and/or stored on MCD 108 for later viewing. In some implementations, one or more back-end servers implementing a service cloud 114 may provide the content analysis and/or visual search functionality described herein. Further, in some implementations, avatar facial and/body modeling may be undertaken to permit a user to interact with the search results displayed on TV screen 104 and/or on mobile display screen 110.

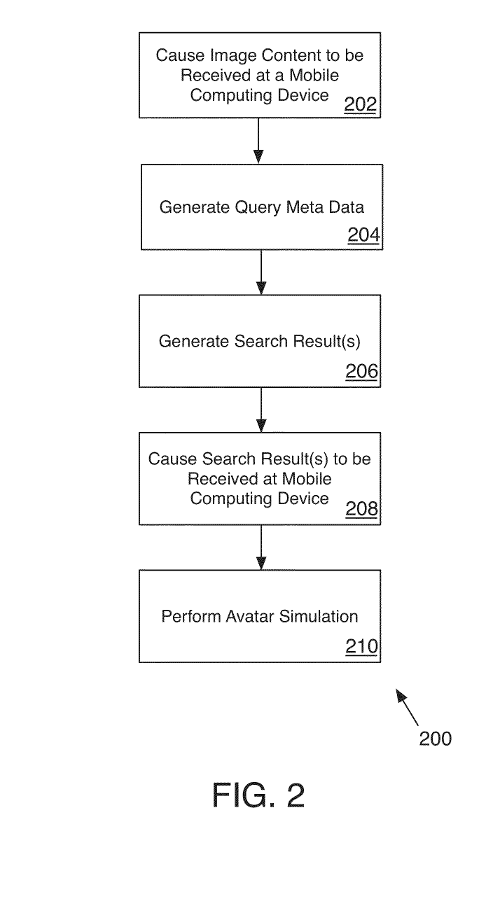

FIG. 2 illustrates a flow diagram of an example process 200 according to various implementations of the present disclosure. Process 200 may include one or more operations, functions or actions as illustrated by one or more of blocks 202, 204, 206. 208, and 210. While, by way of non-limiting example, process 200 will be described herein in the context of example environment 100 of FIG. I, those skilled in the art will recognize that process 200 may be implemented in various other systems and/or devices. Process 200 may begin at block 202,

At block 202, image content may be caused to be received at a mobile computing device. For example, in some implementations, a software application (e.g., an App) executing on MCD 108 may cause TV 102 to provide content 106 to MCD 108 using well known content shifting techniques such as Intel® WiDi® or the like. For example, a user may initiate an App on MCD 108 and that App may set-up a peer-to-peer (P2P) session between TV 102 and MCD 108 using is wireless communication scheme such as WiFi® or the like. Alternatively, TV 102 may provide such functionality in response to a prompt such as a user pushing a button on a remote control or the like.

Further, in other implementations, another device such as a STB (not shown) may provide the functionality of block 202. In yet other implementations, MCD 108 may be provided with meta data specifying content 106 and MCD 108 may use that meta data to obtain content 106 rather than receive content 106 directly from TV 102. For example, the meta data specifying content 106 may include data that specifies a data. stream containing content 106 and/or synchronization data, Such content meta data may enable MCD 108 to synchronize the displaying of content 106 on display 110 with the displaying of content 106 on TV screen 104 using well-known content synchronization techniques. Those of skill in the art will recognize that content shifted between TV 102 and MCD 108 may be adapted to conform with differences between TV 102 and MCD 108 in parameters such as resolution, screen size, media format, and the like. In addition if content 106 includes audio content, a corresponding audio stream on MCD 108 may be muted to avoid echo effects or the like.

At block 204, query meta data may be generated. For example, in various implementations, content analysis techniques such as image segmentation techniques may be applied to image content contained within query region 112 where a user may have selected region 112 by making a gesture. For example, in implementations where mobile display 110 employs touchscreen technology, a user gesture such as a touch, tap, swipe, dragging motion, or the like may be applied to display 110 to select query region 112.

Generating query meta data in block 204 may involve, at least in part, using well-known content analysis techniques such as image segmentation to identify and extract example objects from the content within query region 112. For example, well-known image segmentation techniques such as contour extraction using boundary-based or discontinuity-based modeling techniques, or graph-based techniques, or the like, may be applied to region 112 in undertaking block 204. The query meta data generated may include feature vectors describing the attributes of extracted example objects. For example, the query meta data may include feature vectors specifying object attributes such as color, shape, texture, pattern etc.

In various implementations, the boundary of region 112 may not be exclusive and/or the identification and extraction of example objects may not be limited to objects that appear only within region 112. In other words, an object appearing within region 112 that may also extend beyond the boundaries of region 112 may still be extracted as an example object in its entirety when implementing block 204.

An example usage model for blocks 202 and 204 of process 200 may involve a user viewing content 106 on TV 102. The user may see something of interest in content 106 (e.g., an article of clothing such as a dress worn by an actress), The user may then invoke an App on MCD 108 that causes content 106 to he shifted to mobile display screen 110 and the user may then select region 112 containing the object of interest. Once the user has selected region 112, the content within region 112 may be automatically analyzed to identify and extract one or more example objects as described above. For instance, region 112 may be analyzed to identify and extract an example object corresponding to the article of clothing that is of interest to the user. Query meta data may then be generated for the extracted object(s). For instance, one or more feature vectors may be generated specifying attributes such as color, shape, texture, and/or pattern, etc., for the clothing article of interest.

At block 206, search results may be generated. For example, in various implementations, well-known visual search techniques such as top-down, bottom-up feature based, texture-based, neural network, color-based, or motion-based approaches, and the like may be employed to match the query meta data generated in block 204 to content available on one or more databases and/or available over one or more networks such as the internet. In some implementations, generating search results at block 206 may include searching among targets that differ from distractors by a unique visual feature, such as color, size, orientation or shape. In addition, conjunction searching may be undertaken where targets may not be defined by any single unique visual feature, such as a feature vector, but may be defined by a combination of two or more features, etc.

The matching content may be ranked and/or filtered to generate one or more search results. For example, referring again to environment 100, feature vectors corresponding to example objects extracted from region 112 may be provided to service cloud 114 where one or more servers may undertake visual search techniques to compare those feature vectors against feature vectors stored on one or more databases and/or the internet, etc. to identify matching content and provide ranked search results. In other implementations, content 106 and information specifying region 112 may be provided to service cloud 114 and service cloud 114 may undertake blocks 204 and 206 as described above. In yet other implementations, the mobile computing device that received content at block 202 may undertake all of the processing described herein with respect to blocks 204 and 206.

At block 208, search results may be caused to be received at a mobile computing device. For example, in various implementations, the search results generated at block 206 may be provided to the mobile computing device that received the image content at block 202. In other implementations, the mobile computing device that received content at block 202 may also undertake the processing of blocks 204, 206 and 208.

Continuing the example usage model from above, after generating the search results at block 206, block 208 may involve service cloud 114 conveying the search results back to MCD 108 in the form of a list of visual search results. The search results may then be displayed on mobile display screen 110 and/or stored on MCD 108. For example, if the desired article of clothing is a dress, then one of the search results displayed on screen 110 may be an image of a dress that matches the query meta data generated at block 204.

In some implementations, a user may provide input specifying how query meta data is to be generated in block 204 and/or how search results are to be generated in block 208. For example, a user may specify the generation of query meta data corresponding to texture if the user wants to find something with a similar pattern, and/or the generation of query meta data corresponding to shape if the user wants something with a similar contour, etc. In addition, a user may also specify how search results should be ordered and/or filtered (e.g., by price, popularity, etc.).

At block 210, an avatar simulation may be performed. For example, in various implementations, one or more of the search results received at block 208 may be combined with an image of a user to generate an avatar using well-known avatar simulation techniques. For example, using avatar simulation techniques employing real-time tracking, parameter optimization, advanced rendering and the like, an object corresponding to a visual search result may be combined with user image data to generate a digital likeness or avatar of the user in combination with the object. For instance, continuing the example usage model from above, an imaging device such as a digital camera (not shown) associated with either TV 102 or MCD 108 may capture one or more images of a user. An associated processor, such as a SoC, may then be used to undertake avatar simulation techniques using the captured image(s) so that an avatar corresponding to the user may be displayed with the visual search result appearing as an article of clothing being worn by the avatar.

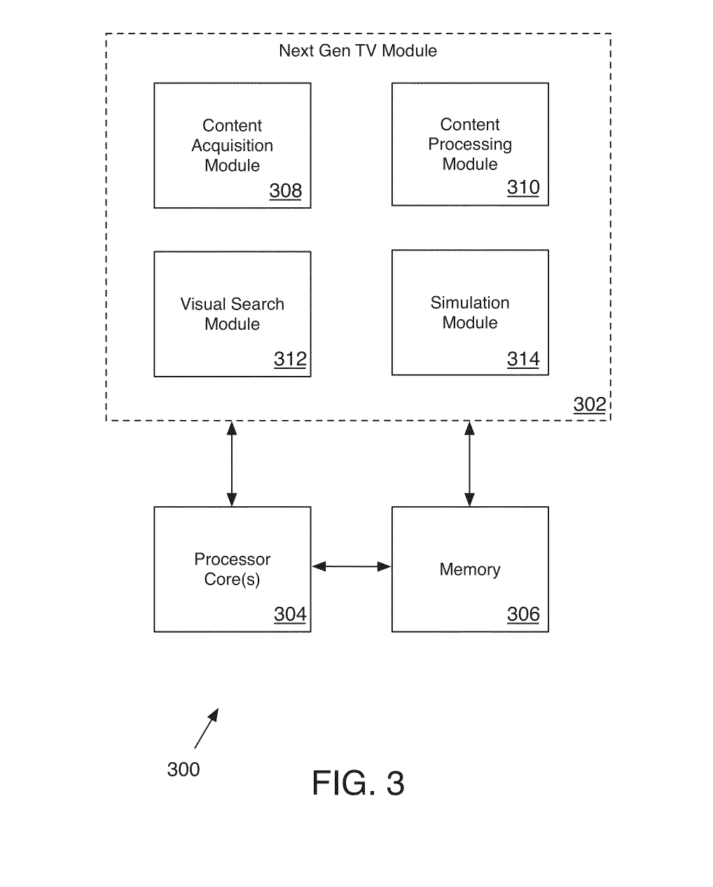

FIG. 3 illustrates an example system 300 in accordance with the present disclosure. System 300 includes a next gen. TV module 302 communicatively and/or operably coupled to one or more processor cores 304 and/or memory 306. Next gen TV module 302 includes a content acquisition module 308, a content processing module 310, a visual search module 312 and a simulation module 314, Processor may provide processing/computational resources to next gen TV module 302, while memory may store data such as feature vectors, search results, etc.

In various examples, modules 308-314 may be implemented in software, firmware, and/or hardware and/or any combination thereof by a device such as MCD 108 of FIG. 1. In other examples, various ones of modules 308-314 may be implemented in different devices. For instance, in some examples, MCD 108 may implement module 308, modules 310 and 312 may be implemented by service cloud 114, and TV 102 may implement module 314. Regardless of how modules 308-314 are distributed among and/or implemented by various devices, a system employing next gen TV module 302 may function together as an overall arrangement providing the functionality of process 200 and/or may be put in service by an entity operating, manufacturing and/or providing system 300.

In various implementations, components of system 300 may undertake various blocks of process 200. For example, referring also to FIG. 2, module 308 may undertake block 308, while module 310 may undertake block 204 and module 312 may undertake blocks 206 and 208. Module 314 may then undertake block 210.

System 300 may be implemented in software, firmware, and/or hardware and/or any combination thereof. For example, various components of system 300 may be provided, at least in part, by software and/or firmware instructions executed by or within a computing system SoC such as a CE system. For instance, the functionality of next gen TV module 302 as described herein may be provided, at least in part, by software and/or firmware instructions executed by one or more processor cores of a mobile computing device such as MCD 108, CE device such as a set-top box, an internes capable TV, etc. In another example implementation, the functionality of next gen TV module 302 may be provided, at least in part, by software and/or firmware instructions executed by one or more processor cores of a next gen TV system such as TV 102.

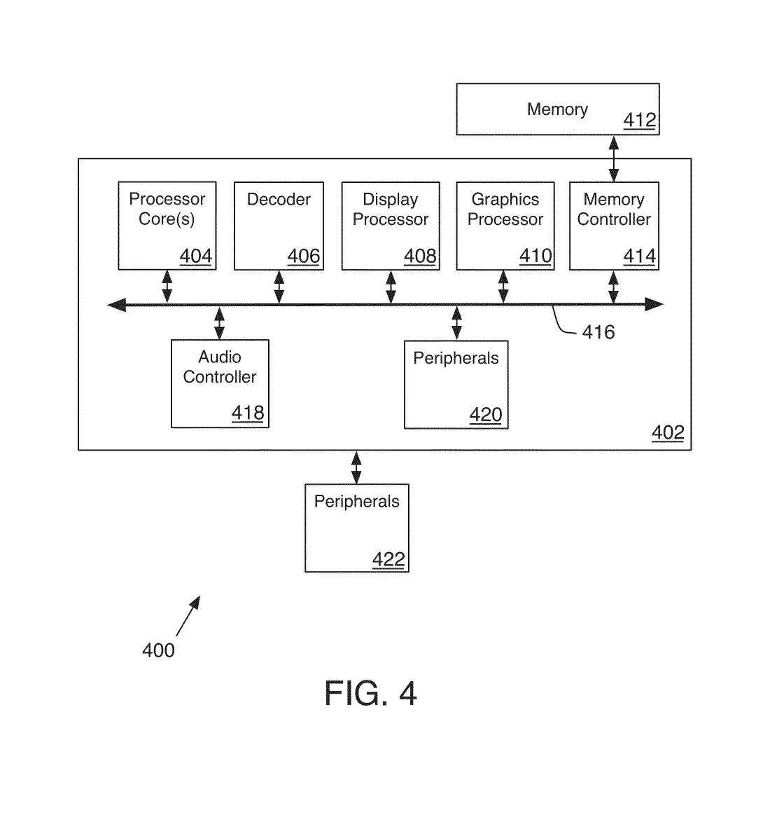

FIG. 4 illustrates an example system 400 in accordance with the present disclosure. System 400 may be used to perform some or all of the various functions discussed herein and may include one or more of the components of system 300. System 400 may include selected components of a computing platform or device such as a tablet computer, a smart phone, a set top box, etc., although the present disclosure is not limited in this regard. In some implementations, system 400 may be a computing platform or SoC based on Intel® architecture (IA) for consumer electronics (CE) devices For instance, system 400 may be implemented within MCD 108 of FIG. 1. It will be readily appreciated by one of skill in the art that the implementations described herein can be used with alternative processing systems without departure from the scope of the present. disclosure.

System 400 includes a processor 402 having one or more processor cores 404. In various implementations, processor core(s) 402 may be part of a 32-bit central processing unit (CPU). Processor cores 404 may be any type of processor logic capable at least in part of executing software and/or processing data signals. In various examples, processor cores 404 may include a complex instruction set computer (CIBC) microprocessor, a reduced instruction set computing (RISC) microprocessor, a very long instruction word (VIJAY) microprocessor, a processor implementing a combination of instruction sets, or any other processor device, such as a digital signal processor or microcontroller. Further, processor core(s) 404 may implement one or more of modules 308-314 of system 300 of FIG. 3.

Processor 402 also includes a decoder 406 that may be used for decoding instructions received by, e.g., a display processor 408 and/or a graphics processor 410, into control signals and/or microcode entry points. While illustrated in system 400 as components distinct from core(s) 404, those of skill in the art may recognize that one or more of core(s) 404 may implement decoder 406, display processor 408 and/or graphics processor 410.

Processing core(s) 404, decoder 406, display processor 408 and/or graphics processor 410 may be communicatively and/or operably coupled through a system interconnect 416 with each other and/or with various other system devices, which may include but are not limited to, for example, a memory controller 414, an audio controller 418 and/or peripherals 420. Peripherals 420 may include, for example, a unified serial bus (USB) host port, a Peripheral Component Interconnect (PCI) Express port. a Serial Peripheral Interface (SPI) interface, an expansion bus, and/or other peripherals, While FIG. 4 illustrates memory controller 414 as being coupled to decoder 406 and the processors 408 and 410 by interconnect 416, in various implementations, memory controller 414 may be directly coupled to decoder 406, display processor 408 and/or graphics processor 410.

In some implementations, system 400 may communicate with various I/O devices not shown in FIG. 4 via an I/O bus (also not shown). Such I/O devices may include but are not limited to, for example, a universal asynchronous receiver/transmitter (VART) device, a USB device, an I/O expansion interface or other I/O devices. In various implementations, system 400 may represent at least portions of a system for undertaking mobile, network and/or wireless communications.

System 400 may further include memory 412. Memory 412 may be one or more discrete memory components such as a dynamic random access memory (DRAM) device, a static random access memory (SRAM) device, flash memory device, or other memory devices. While FIG. 4 illustrates memory 412 as being external to processor 402, in various implementations, memory 412 may be internal to processor 402 or processor 402 may include addition, internal memory (not shown). Memory 412 may store instructions and/or data represented by data signals that may be executed by the processor 402. In some implementations, memory 412 may include a system memory portion and a display memory portion.

The systems described above, and the processing performed by them as described herein, may be implemented in hardware, firmware, or software, or any combination thereof In addition, any one or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including a computer readable medium having computer program logic stored therein to cause a computer system to perform one or more features and/or combinations of features disclosed herein.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

What is claimed is:

1. A system for facilitating user interaction with image content displayed on a television, comprising:
a content acquisition module configured to cause image content to be received at a mobile computing device, wherein the image content is being contemporaneously displayed on a television;
an content processing module configured to generate query meta data by performing content analysis on a query region of the image content; and
a visual search module configured to perform a visual search using the query meta data and to display at least one corresponding search result on the mobile computing device.

2. The system of claim 1, further comprising:
a simulation module configured to perform avatar modeling in response to at the at least one search result and to at least one image of a user.

3. The system of claim 1. wherein performing content analysis on the query region comprises performing image segmentation on the query region.

4. The system of claim 1, wherein the content acquisition module is configured to provide the image content by transferring the content from the television to the mobile computing device.

5. The system of claim 1, wherein the content processing module is configured to generate query meta data by extracting feature vectors from the query region.

6. The system of claim 1, wherein the mobile computing device includes a touchscreen display, and wherein the query region comprises a portion of the image content determined at least in part in response to a user gesture applied to the touchscreen display.

7. The system of claim 6, wherein the user gesture comprises at least one of a touch, tap, swipe or dragging gesture.

8. The system of claim 1, wherein the television comprises a television display screen, and wherein the television display screen has a larger diagonal size than a diagonal size of a display screen of the mobile computing device.

9. A method for facilitating user interaction with image content displayed on a television, comprising:
causing image content to be received at a mobile computing device, wherein the image content is contemporaneously displayed on a television;
generating query meta data by performing content analysis on a query region of the image canter
generating at least one search result by performing a visual search using the query meta data; and
causing the at least one search result to be received at the mobile computing device.

10. The method of claim 9, further comprising:
performing an avatar simulation in response to the at least one search result and in response to at least one image of a user.

11. The method of claim 9, wherein causing image content to be received at the mobile computing device comprises causing the image content to be transferred from the television to the mobile computing device.

12. The method of claim 9, wherein generating query meta data by performing content analysis on the query region of the image content comprises performing the content analysis at one or more back-end servers.

13. The method of claim 9, wherein generating the least one search result by performing the visual search using the meta data comprises performing the visual search at one or more back-end servers.

14. The method of claim 9, wherein performing content analysis comprises performing image segmentation.

15. The method of claim 9, further comprising:
causing content meta data to be received at the mobile computing device; and
using, at the mobile computing device, the content meta data to identify the image content.

16. The method of claim 15, wherein the using the content meta data to identify the image content comprises using the content meta data to identify a data stream corresponding to the image content.

17. An article comprising a computer program product having stored therein instructions that, if executed, result in:
causing image content to be received at a mobile computing device, wherein the image content is contemporaneously displayed on a television;
generating query meta data by performing content analysis on a query region of the image content:
generating at least one search result by performing a visual search using the query meta data; and
causing the at least one search result to be received at the mobile computing device.

18. The article of claim 17, having stored therein further instructions that, if executed, result in:
performing an avatar simulation in response to the at least one search result and in response to at least one image of a user.

19. The article of claim 17, Wherein causing image content to be received at the mobile computing device comprises causing the image content to be transferred from the television to the mobile computing device.

20. The article of claim 17, wherein performing content analysis comprises performing image segmentation.
